(19) United States
(12) Patent Application Publication
(10) Pub. No.: US 2010/0134631 A1
(43) Pub. Date: Jun. 3, 2010

(54) APPARATUS AND METHOD FOR REAL TIME IMAGE COMPRESSION FOR PARTICLE TRACKING

(75) Inventors: Greg Voth, Rocky Hill, CT (US); Dominick Stich, Nashville, TN (US); King-Yeung Chan, Astoria, NY (US)

Correspondence Address: PILLSBURY WINTHROP SHAW PITTMAN, LLP, P.O. BOX 10500, MCLEAN, VA, 22102, US

(73) Assignee: WESLEYAN UNIVERSITY, Middletown, CT (US)

(21) Appl. No.: 12/447,792

(22) PCT Filed: Oct. 25, 2007
(86) PCT No.: PCT/US07/82509

§ 371 Date: Feb. 4, 2010

Related U.S. Application Data
(60) Provisional application No. 60/863,465, filed on Oct. 30, 2006.

(51) Int. Cl. H04N 5/225; G06K 9/36; G06K 9/00

(52) U.S. Cl. 348/169; 382/239; 382/103; 348/E05.024

(57) ABSTRACT

A real-time image compression method includes identifying pixels in a set of image data that have a brightness value past a predetermined threshold; determining a position of each identified pixel in the image data; and for each of the identified pixels, defining a vector that includes the brightness value and the position of the identified pixel in the image data.

### CROSS-REFERENCE TO RELATED APPLICATIONS

The present invention claims priority to U.S. Provisional Patent Application No 60/863,465 filed on Oct. 30, 2006, the entire content of which is hereby incorporated by reference.

### FIELD

The present invention relates to a real-time image compression method, a real-time image compression circuit and a camera including such circuit.

### BACKGROUND

Optical particle tracking has become an important tool in the study of fluids and soft materials. In the studies of turbulent fluids, stereoscopic high-speed digital imaging to reconstruct three-dimensional (3D) trajectories of particles may be used. However, this approach may face serious constraints due to the huge data rates produced by multiple high-speed video cameras. Many of the other approaches to particle tracking such as acoustic tracking, confocal imaging, and holographic imaging may also produce huge data rates. The use of images to extract 3D trajectories with high spatial resolution, high temporal resolution, and long duration may require rapid acquisition of huge data sets.

One configuration may use a Basler A504k camera that records 1280×1024 pixel images at 500 Hz. However, any digital camera may be used, with any resolution and image frequency. For example, cameras have recently become available that, for example, can take 600×800 images at 6700 Hz. Any of these CMOS cameras may be able to achieve higher frame rates by decreasing the spatial resolution since the limiting factor is the data transfer rate. The data rate from some cameras is 625 MB/s, and storing this data stream may be currently impractical with anything other than a random access memory (RAM). For example, if only 4 GB of RAM is available for each camera, only 6.5 seconds of data may be able to be recorded before waiting for the much slower transfer to hard disk. The large volume of data may also require a very long processing time.

Various avenues may be pursued to account for the huge data rate generated during optical particle tracking experiments. For example, in order to limit the huge data rate, Ott and Mann (S. Ott and J. Mann, Journal of Fluid Mechanics 422, 207 (2001)) have suggested accepting the low space and time resolution available from standard PAL video cameras. As another example, Voth et al (G. A. Voth, A. L. Porta, A. M. Crawford, E. Bodenschatz, C. Ward, and J. Alexander, Review of Scientific Instruments 72, 4348 (2001)) have built custom imagers that allow ID projection imaging at 70 kHz. In yet another example, Ouelette et al (N. T. Ouellette, H. Xu, and E. Bodenschatz, Experiments in Fluids 40, 201 (2006)) have decreased the spatial resolution of high speed video cameras to 256×256 pixels in order to achieve 27 kHz imaging rate.

### SUMMARY

The images produced in particle tracking experiments are typically quite simple, consisting of small particle images on an uninteresting background. A technique for extracting the desired information from the particle images while ignoring the background information may allow a greatly reduced data stream, which may allow increased data acquisition time, increased frame rates, or increased spatial resolution.

In an aspect of the invention, there is provided a method of tracking a flow in a fluid medium including injecting a plurality of particles into the flow; imaging the particles and fluid using a high speed digital video camera; compressing images provided by the high speed digital video camera in real-time during the imaging; and processing the compressed images.

In another aspect of the invention, there is provided a method of tracking objects including imaging the objects using a high speed digital video camera; compressing images provided by the high speed digital video camera in real-time during the imaging, the compressing including thresholding to select pixels in the images in accordance with respective brightness values for the pixels, and defining a vector for each pixel that includes the brightness value and a position of the pixel in the images; and processing the compressed images.

In yet another aspect of the invention, there is provided a system for tracking a flow in a fluid medium including a high speed digital video camera configured to image particles in the fluid; a compression circuit configured to compress images provided by the high speed digital video camera in real-time during the imaging, the compression circuit including a processing system that is configured to filter image data provided by the high speed digital video camera to remove data related to portions of the images in which there are no imaged particles; and a storage medium configured to store the compressed images.

In an aspect of the invention, there is provided a real-time image compression method including identifying pixels in a set of image data that have a brightness value past a predetermined threshold; determining a position of each identified pixel in the image data; and for each of the identified pixels, defining a vector that includes the brightness value and the position of the identified pixel in the image data.

In another aspect of the invention, there is provided a real-time image compression method including receiving a plurality of groups of pixels that define an image frame; processing each of the plurality of groups of pixels, the processing including identifying pixels in each group of pixels that have a brightness value past a predetermined threshold; and determining a position of the identified pixels in the image frame; and for each of the identified pixels, defining a vector that includes the brightness value and the position of the identified pixel in the image frame, the vector having a same number of bytes as a sequence defined by each group of pixels.

In yet another aspect of the invention, there is provided a real-time image compression circuit including a plurality of filters configured to identify pixels in a set of image data that have a brightness value past a predetermined threshold; a plurality of memory devices configured to store brightness information related to the identified pixels, the brightness information including a brightness value and a position of each of the identified pixels in the image data; and a multiplexer configured to define for each identified pixel a vector that includes the brightness value and the position of the identified pixel in the image data.

In yet another aspect of the invention, there is provided a real-time image compression circuit including an input configured to receive a plurality of groups of pixels that define an image frame; a plurality of filters configured to process each group of pixels one at a time and to simultaneously identify pixels in each group of pixels that have a brightness value past a predetermined threshold; a plurality of memory devices configured to store brightness information related to the identified pixels, each memory device in the plurality of memory devices coupled to a corresponding filter of the plurality of filters, the brightness information including a brightness value and a position of each of the identified pixels in the image frame; and a multiplexer configured to define for each identified pixel a vector that includes the brightness value and the position of the identified pixel in the image data.

In yet another aspect of the invention, there is provided a camera including an optical system configured to capture images of a scene; a processing system configured to output a set of image data based on the captured images; and an image compression circuit configured to compress the captured images in real time, the circuit including a plurality of filters configured to identify pixels in a set of image data that have a brightness value past a predetermined threshold; a plurality of memory devices configured to store brightness information related to the identified pixels, the brightness information including a brightness value and a position of each of the identified pixels in the image data; and a multiplexer configured to define for each identified pixel a vector that includes the brightness value and the position of the identified pixel in the image data.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 shows a system for use in high-speed particle tracking in accordance with an embodiment of the invention;

FIG. 2 show a method of tracking a flow in accordance with an embodiment of the invention;

FIG. 3 shows the real-time image compression circuit in accordance with an embodiment of the invention;

FIG. 4 shows a layout of the field-programmable gate array in accordance with an embodiment of the invention;

FIG. 5 is a conceptual diagram showing an image compressed into vectors using the compression circuit in accordance with an embodiment of the invention;

FIG. 6 shows a compression method in accordance with an embodiment of the invention;

FIGS. 7a-c show a comparison of a 10 byte array in an uncompressed format and in a compressed format;

FIGS. 8a-d show an original uncompressed image and a compressed image in accordance with an embodiment of the invention;

FIG. 9a shows deviation between particle positions measured from compressed images and the original positions measured from uncompressed images for several different values of the threshold; and

FIG. 9b shows the number of filtered pixels for each threshold.

### DETAILED DESCRIPTION

High-speed particle tracking with digital video may create very large data rates and as a result experimenters are generally forced to make compromises between spatial resolution, temporal resolution, and the duration over which data is acquired. The images produced in particle tracking experiments may contain a large amount of black space with relatively few bright pixels. In order to reduce the huge amount of data produced during high-speed particle tracking experiments, an image compression scheme may be used in an embodiment of the invention.

In an embodiment, there is provided a system for real-time compression of high-speed video and a real-time compression method that significantly reduce data volume and lengthen data duration in high-speed particle tracking experiments. The compression system and the compression method may be applied to any image capture environment where a significant percentage of pixels are unchanged, including, for example, time-resolved particle image velocimetry, sky surveying, and traffic monitoring.

In an embodiment, an image compression digital circuit may be placed between a camera and a frame grabber to compress data in real-time. The image compression circuit may be conveniently used with any type of camera and frame grabber or other digital input or storage device. In an embodiment, the compression ratio for an image ranges from 100 to 1000 and varies dynamically depending on the number of filtered pixels. In other embodiments of the invention, compression ratios greater than 1000 may also be achieved. The reduced data rate makes it possible to write images directly to hard disk. While previously data might only be able to be acquired up to the capacity of any dedicated video RAM, the digital circuit may acquire full resolution data and write continuously for up to a week into a hard drive, in an embodiment of the invention.

The image data compressed by the image compression circuit may be processed in real-time, for example by a host computer. Real-time image processing may include, for example, reconstructing the motion of an object in a particular environment such as the motion of particles in a fluid medium. Alternatively, the compressed images may be stored temporarily, for example in the host computer, for future use. It will be appreciated that the term “processing” is not limited to real-time image processing or image storing. Rather, the term “processing” is intended to encompass any procedure that involves the compressed images.

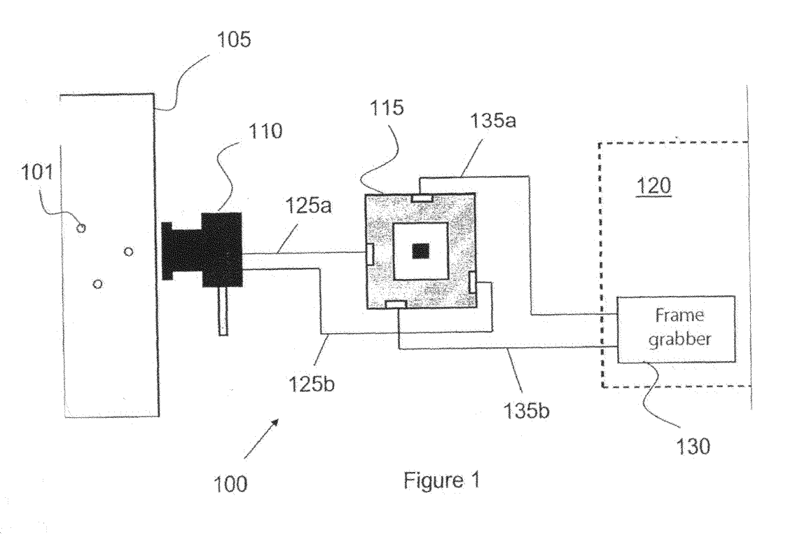

FIG. 1 shows a system 100 for use in high-speed particle tracking in accordance with an embodiment of the invention. The system 100 is adapted to track and reconstruct three-dimensional (3D) trajectories of particles 101 located in a tank 105. The system 100 includes a camera 110, a real-time image compression circuit 115 and a computer 120. The camera, 110 may be a high-speed camera, for example a A504k high speed CMOS camera manufactured by Basler AG, that is adapted to produce 500 frames per second at a frame resolution of 1280*1024 pixels. The input data from the camera is clocked at 67.58 MHz. Thus, the images are captured at rates much higher than conventional video cameras. In each clock cycle, the camera 110 is adapted to output 10 pixels, with each pixel occupying 1 byte or 8 bits. It will be appreciated that any high speed camera may be used in other embodiments of the invention. The term “high speed camera” is intended to encompass any camera having an elevated rate of image acquisition. The high speed camera may be used for recording slow-motion playback films or for scientific study of transient phenomena. In an embodiment, the high speed camera has a rate of image acquisition of at least one hundred images per second.

The computer 120 also includes a frame grabber 130 that receives normal camera frames that contain data encoded by the real-time image compression circuit 115 instead of original pixels. The frame grabber 130 may be, for example, an EPIX E4 frame grabber manufactured by EPIX.

The camera 110 is connected to the real-time image compression circuit 115 by way of serial camera link cables 125a,b. The real-time image compression circuit 115 is connected to the frame grabber 130 embedded in the computer 120 by way of serial camera link cables 135a,b. The real-time image compression circuit 115 compresses data in real-time without using the processor(s) of the host computer 120, so that data size is reduced before they reach the processing machine. The circuit 115 is designed to receive and recreate the original signal format of the camera 110 and frame grabber 130 so that neither of them has to be modified internally to use the circuit 115.

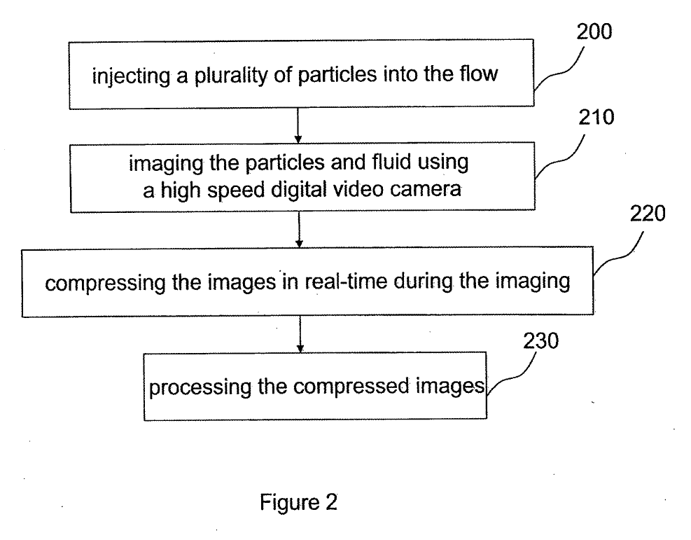

Referring now to FIG. 2, this figure shows a method of tracking a flow in accordance with an embodiment of the invention. The method begins at procedure 200 in which a plurality of particles 101 are injected into the flow, for example in the tank 105. Then, the method proceeds to procedure 210 in which the particles 101 and the fluid contained in the tank 105 are imaged using a high speed digital video camera 110. At procedure 220, the images captured by the high speed video camera 110 are compressed using the real-time image compression circuit 115. Image compression occurs during acquisition of the images by the camera 110. Then, the method ends at procedure 230 in which the compressed images are processed.

In an embodiment, a plurality of cameras 110 may be used to monitor the particles 101. One configuration may use between 2 and 4 high speed cameras. Other configurations may use any number of high speed cameras, placed in any positions and at any angles. Information or data collected from the set of image data, which are captured by the one or more cameras 110 and transmitted to the computer 120, may include, for example, brightness value of the particles, location of the particles, eccentricity and radius of gyration of the particles. The information obtained from the set of image data and compression by the circuit 115 may be used for further processing such as, for example, feature motion tracking in real time or 3 dimensional (3D) stereometric reconstruction of particle location in space. It will be appreciated that additional information may be extracted from the image data in other embodiments of the invention.

In an embodiment, the compression factors that may be obtained with the circuit 115 are in a range between about 100-1000, depending on the number of bright particles present in the tank 105. In another embodiment, compression factors above 1000 may also be obtained. Since the data transfer rate is significantly reduced, data may be directly written to hard drive, whose memory capacity is much larger. The reduction in data volume and the increase in storage capacity enables the system 100 to record for up to a week instead of seconds. The time for data processing and analysis may also be significantly reduced. The compression system may be applied to any image capture environment where a significant percentage of pixels are unchanged, including for example, time-resolved particle image velocimetry, sky surveying, and traffic monitoring.

The compression factor is highly dependent on the particle density in the image frame. It will be appreciated that lower compression factors may still be greatly beneficial in images with high particle density. In an embodiment, a compression factor of at least about 10 may be obtained in images with a high density of particles, for example, at least one hundred particles. A compression factor as low as 10 may still be useful in some configurations as it may allow for real-time image storage. In an embodiment, each particle may occupy about 20 pixels.

The compression circuit 115 is configured to compress images by removing data related to portions of the images in which there are no imaged particles. Various compression schemes may be used to remove image data. For example, in an embodiment of the invention, the circuit 115 may be configured to threshold the input pixels. The thresholding scheme may be done by comparing the input pixels with a threshold value, and define a vector containing the brightness and position of the bright pixels. In another embodiment, the thresholding scheme may be done by selecting pixels with a large gradient in the intensity. This approach may be used to identify lines or particles edges in an image. Additional compression and thresholding schemes may be used in other embodiments of the invention including, for example, wavelets filters. It will be appreciated that the compression schemes that are executed by circuit 115 are not limited to those discussed herein. Quite to the contrary, a variety of other compression schemes may be used in other embodiments of the invention.

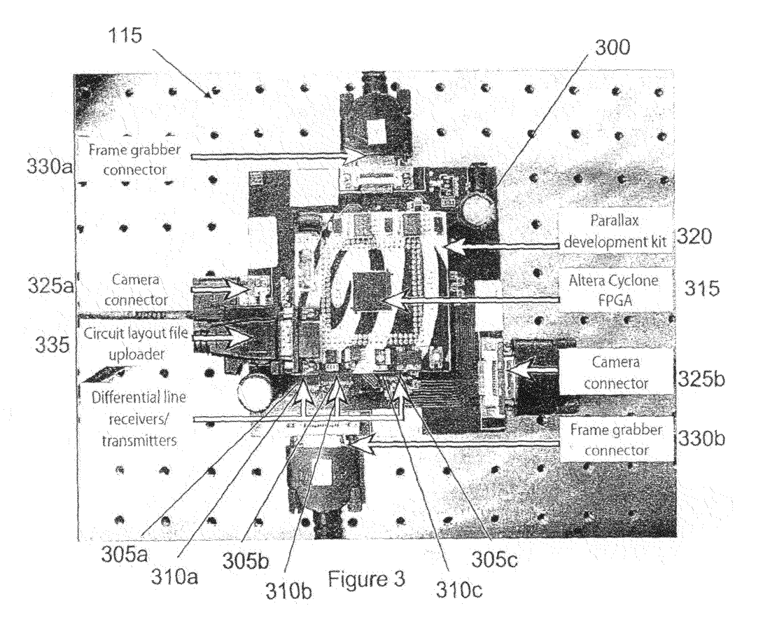

FIG. 3 shows the real-time image compression circuit 115 in accordance with an embodiment of the invention. The circuit 115 includes a circuit board 300, camera link differential line receivers 305a-c, differential transmitters 310a-c, a field-programmable gate array (FGPA) 315 and a parallax development kit 320. The circuit 115 also includes inputs 325a,b that receive, respectively, serial camera link cables 125a,b and outputs 330a,b that receive, respectively, serial camera link cables 135a,b. The circuit 115 further includes a circuit layout file uploader 335 configured to upload circuit layout files from the computer 120 to the FPGA 315.

The real-time image compression circuit 115 receives and transmits data through two pairs of serial camera link cables 125a,b and 135a,b. Camera link differential line receivers 305a-c are implemented on the circuit board 300 to convert signals from serial (coming from the camera 110) to parallel format to be read by the compression processor (FPGA). Differential transmitters 330a,b then encode the compressed data back into serial camera link format for output. These components are mounted on the circuit board 300. The circuit board 300 may be custom designed using, for example, circuit design software provided by Pad2 Pad. Situated in the middle of circuit board 300 is the field-programmable gate array (FPGA) 315. In an embodiment, the FPGA 315 is capable of working above 200 MHz, and so is easily able to handle the camera clock of 67.58 MHz of the A504k high speed CMOS camera. The use of the FPGA 315 may be greatly beneficial in that it provides versatility and parallel processing capabilities. The FPGA 315 is mounted on the Parallax hardware development kit 320, which allows for the convenient upload of circuit layout files from the computer 120 to the FPGA 315. In an embodiment, the circuit layout may be designed and tested using Quartus II, a free development software provided by Altera, using Verilog HDL (hardware description language). Another benefit of using the FPGA 315 is that its programmability allows for convenient expansion and modification of the system.

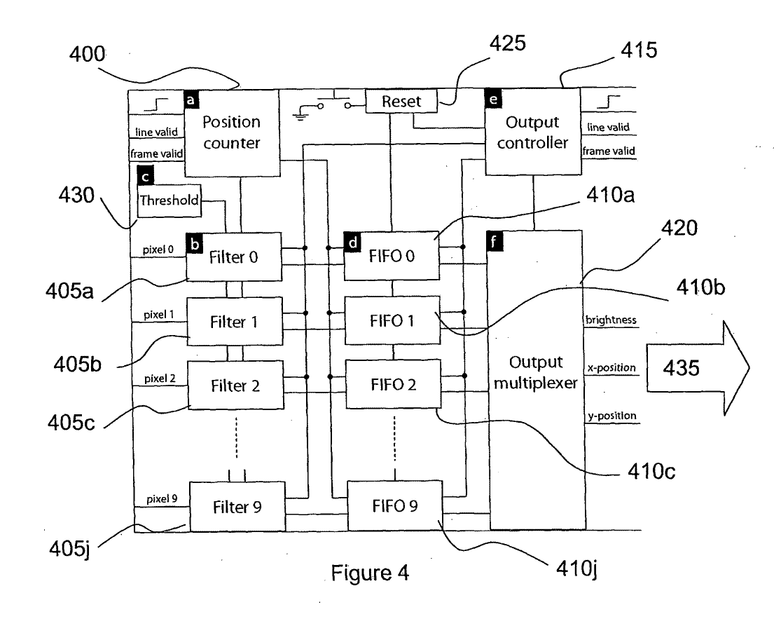

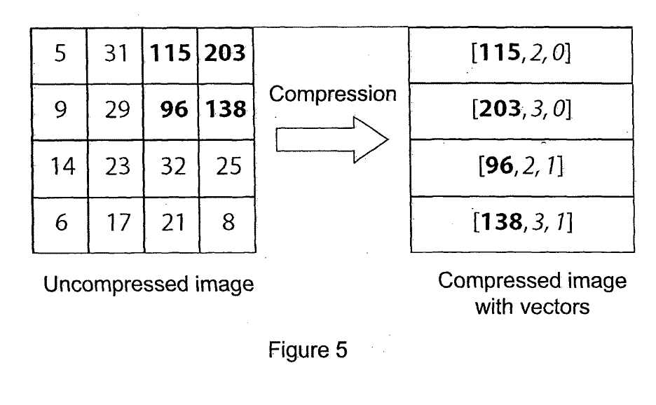

FIG. 4 shows a layout of the FPGA 315 in accordance with an embodiment of the invention. The FPGA 315 is configured to filter pixels according to a built-in threshold value and output the bright pixels as a vector of location and brightness. FIG. 5 is a conceptual diagram showing an image compressed into vectors using the FPGA 315. Each vector includes a brightness value and the position of the pixel. In the example of FIG. 5, a threshold of 35 is used.

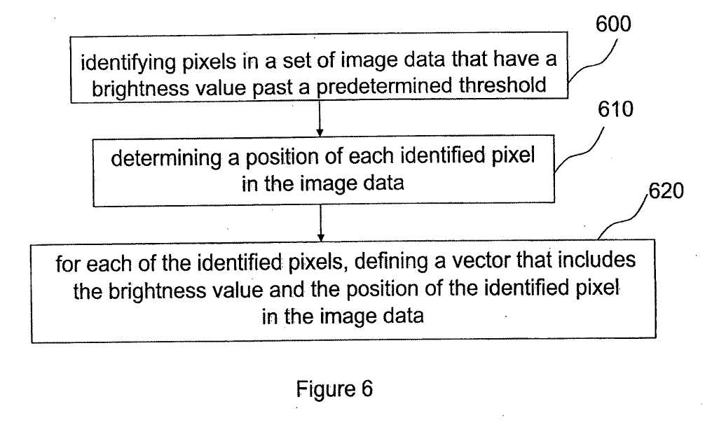

The FPGA 315 is adapted to compress image data in accordance with the method shown in FIG. 6. The method of FIG. 6 begins at procedure 600 in which pixels that each have a brightness value past a predetermined threshold are identified in a set of image data. The method then proceeds to procedure 610 in which a position of each identified pixel in the image data is determined. The method further proceeds to procedure 620 in which, for each of the identified pixels, a vector that includes the brightness value and the position of the identified pixel in the image data is defined. In an embodiment, pixels having a brightness value above the predetermined threshold are identified and selected. In another embodiment, pixels having a brightness value below the predetermined threshold are selected.

Referring back to FIG. 4, the FPGA 315 includes a position counter 400, a plurality of filters 405a-j, a plurality of memory devices 410a-j, an output controller 415 and an output multiplexer 420.

The input data from the high speed camera 110 is clocked at 67.58 MHz in an embodiment of the invention. In an embodiment, in each clock cycle, ten pixels (8-bits per pixel) are received in parallel. It will be appreciated that fewer or more than 10 pixels may be received by the circuit 115 in another embodiment of the invention. The circuit 115 also receives a frame valid bit indicating frame breaks, a line valid bit indicating line breaks, and three other camera configuration/trigger signals which are unchanged by the circuit 115. The three other camera configuration/trigger signals include signals provided by serial buses for camera configuration and a trigger line. In an embodiment, camera configuration and/or trigger commands may be passed from the camera directly to the frame grabber 130. The frame valid bit and the line valid bit are inputted to the position counter 400. The pixels are transferred line by line in a left-to-right, top-to-bottom manner. The maximum resolution of a frame is 1280×1024 pixels in an embodiment of the invention. The position counter 400 keeps track of the current pixel position according to the pixel clock, frame valid bit and line valid bit. In an embodiment, the x position is counted in tens (0-127, at maximum resolution), since a group of 10 pixels come in parallel in each clock cycle. However, it will be appreciated that the counting scheme may change depending on the number of bytes or pixels received by the circuit 115 during each camera clock cycle.

In the embodiment of FIG. 4, ten parallel filters 405a-j are configured to compare incoming pixels with a preset threshold value 430. The threshold value 430 may be set and easily changed by the software application that controls the FPGA 315. If a pixel has a brightness value past (e.g. higher than) the threshold 430, the filter sends its brightness to the corresponding memory device 410a-j. As shown in FIG. 4, the filters 405a-j are in communication with the position counter 410 so that each filter 405a-j is able to also maintain a counter for how many bright pixels it has passed through in a frame. In an embodiment, the memory devices 410a-j are first-in-first-out (FIFO) memory devices of length 1000 words and width 25 bits, which are used to store the brightness and location data. Each memory device 410a-j receives the brightness information from its corresponding filter 405a-j and the position from the position counter 400. In the embodiment of FIG. 4, each memory device 410a-j receives a total of 25 bits, including 8 bits for brightness and 17 bits for the pixel position. The x position (i.e. position in a line) of each pixel is coded with 7 bits since the x position is counted in tens. The y position is coded with 10 bits.

It will be appreciated that the storage capacity of the memory devices 410a-j may change depending on the desired resolution of the images. For example, in an embodiment of the invention, the storage capacity of the memory devices 410a-j may be greater than 1000 words. In addition, the number of bits for each word may be greater or smaller than 25 bits depending on the type of camera that is being used. In an embodiment, the number of bits that is used to specify a pixel may be changed by the software application that controls the FPGA 315.

Furthermore, it will be appreciated that the number of filters used in the FPGA 315 may be greater than the number of pixels or bytes that are received during each clock cycle of the camera.

The output controller 415 is configured to read out data stored in the memory devices 410a j. While the data in the memory devices 410a-j are being read out by the output controller 415, pixels from the next frame are being transferred in simultaneously. Therefore, the actual capacity of each memory device 410a-j may be only half of its size, and may result in the maximum number of bright pixels allowed from each filter in one frame being only 500 in an embodiment of the invention. In an embodiment, not more than 5000 bright pixels may be stored from any frame, and in practice the limit may be somewhat less than this because some memory devices may overflow before others are filled. The output controller 415 recreates a new camera frame containing the compressed data. The output controller 415 follows the same signal timing rules that the camera uses. At the end of each frame, the output controller 415 gets the number of bright pixels from the counters in the filters and begins to clock out the correct number of bright pixel vectors out of each memory device 410a j. Since each FIFO contains data from two frames at the same time, the counters may be used for distinguishing between data from the current frame and from the next frame.

The output multiplexer 420 is configured to relay the data output from the memory devices 410a-j to the output bus 435. The output multiplexer 420 is responsible for calculating the exact x coordinate for output, as the x position was only counted in tens up to this point. The number of bits needed by the x position is now 11 (0-1279, at maximum resolution), which increases the output bits to 29 bits, including 8 for brightness, 11 for the x position of each pixel and 10 for the y position of each pixel.

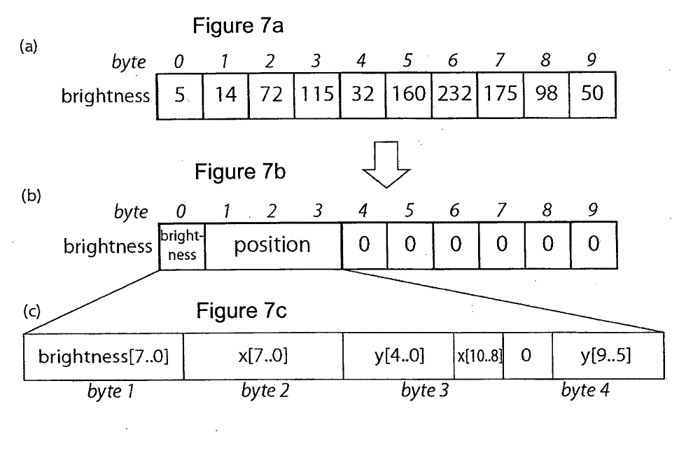

The circuit 115 is configured to imitate the structure of a camera frame, outputting data in, for example, a ten-byte-per-cycle format. The byte arrangements in a clock cycle are shown in FIGS. 7a-c. FIGS. 7a-c show a comparison between a group of 10 pixels or a 10-byte array received by the filters 405a-j in accordance with an embodiment of the invention. In FIG. 7a, in an uncompressed array, each pixel occupies one byte. The pixel value is the brightness of the pixel. In a compressed array shown in FIG. 7b, each bright pixel vector may also occupy 10 bytes. Bytes 0-3 contain the bright pixel information whose breakdown is shown in FIG. 7c. In this embodiment, bytes 4-9 are zero. It will be appreciated that the vectors defined by the compression circuit 115 may include a number of bytes that is different from that of the original group of pixels received by the circuit 115.

In an embodiment of the invention, the compression scheme may also include adding the brightness values for neighboring pixels to the ones that have met the selection criteria (i.e. past the predetermined threshold). This may improve the ability to find positions and properties of the bright features without adding much additional data.

In another embodiment, a different approach may be used to store the pixel positions. For example, it may be possible to use a binary tree to indicate which sections of the image have selected pixels and then which sections of each of these sections have selected pixels, and then finally which pixels in that each sub-sub-section. In this alternative approach, a vector of brightness values for all selected pixels may also be defined.

Furthermore, in an embodiment, a block encoding scheme may be used in which one pixel's coordinates are defined. Then, the relative coordinates of near-by pixels followed by a vector of brightness values are defined.

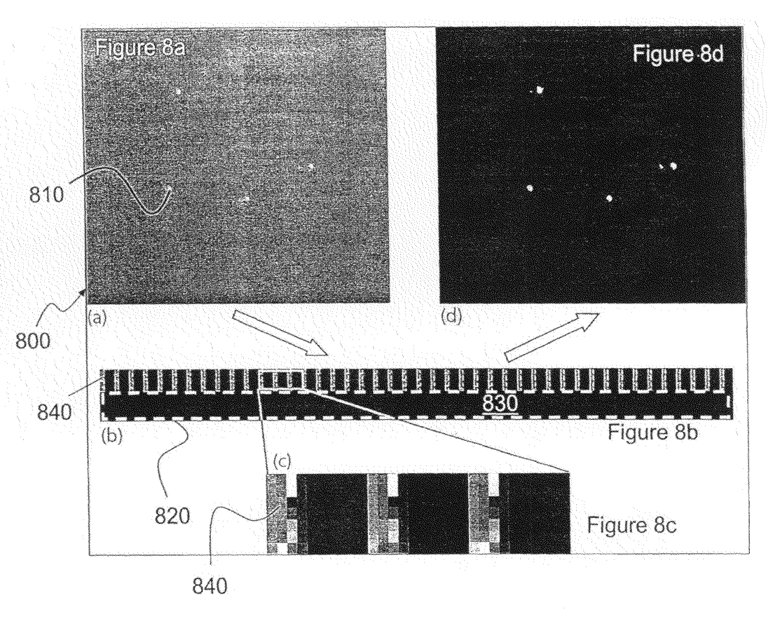

A visualization of an original uncompressed image and a compressed image is shown in FIGS. 8a-d. FIG. 8a shows an original uncompressed image frame 800 including a plurality of bright pixels 810. The uncompressed image frame 800 is captured by the high speed camera 115 and transmitted to the real-time image compression circuit 115. The circuit 115 compresses the image frame 800 in accordance with, for example, the scheme discussed in FIGS. 4-7. For example, the compression circuit 115 receives a plurality of groups of pixels (e.g. 10 pixels), i.e. a set of image data, outputted by the high speed video camera 110. Each group of pixels defines a sequence of a predetermined number of bytes, e.g. 10 bytes. Each group of pixels is transmitted to the circuit 115 during each clock cycle of the high speed video camera 110. The groups of pixels are filtered one at a time by the compression circuit 115. The pixels of a group of pixels are filtered with corresponding filters 405a-j to identify pixels that have a brightness value past a predetermined threshold. The compression circuit 115 further stores the identified pixels having a brightness value past a predetermined threshold in a plurality of memory devices 410a-j. Once all the pixels of a frame have been filtered, the output controller 415 reads out the data stored in the memory devices 410a-j of the circuit 115 and recreates a new camera frame containing the compressed data. The output controller 415 determines the number of vectors out of each memory device 410a-j that are part of an image frame. The output multiplexer 420 receives the brightness value and the position of each bright pixel from the memory devices and calculates the exact x position of each pixel, as the x position was previously counted based on the length of the sequence defined by each group. The output multiplexer 420 outputs a vector for each identified pixel having a brightness value past the predetermined threshold.

In an embodiment, assuming that no more than 5000 pixels are present in an image frame, data may potentially only occupy the top 40 lines in a compressed frame having a maximum resolution of 1280*1024 pixels because 5000 bright pixels vectors fill 39.06 lines. When there are fewer bright pixels, fewer lines are occupied, since data after the last bright pixel vector will be zero.

FIG. 8b shows the compressed image frame 820 obtained after compression of the image frame 800. The black space 830 at the bottom of the compressed image frame 830 shows that there are no more bright pixels in that frame. FIG. 8c is a zoomed view of columns 840 in the compressed image frame 820. The columns 840 are 4 bytes wide and contain the pixel vectors. The other 6 bytes are zero. FIG. 8d shows a decompressed image frame 850 after decompression of the compressed image frame 820. Decompression may be done by software after recording the compressed images.

In an embodiment, a software application may be designed to interface with the compression system and serve as an imaging application to visualize and record data using the setup of FIG. 1. The software application includes machine executable instructions that are adapted to perform various procedures. For example, the software application may include machine executable instructions to record the compressed data to hard drive in real-time. The software application may also include machine executable instructions to display live decompressed images at, for example, 10 frames per second for visualization. The software application may also include machine executable instructions to communicate with the high speed video camera 110 to configure basic settings such as frame rate, exposure, gain, and area of interest. In an embodiment, the software application may be developed in Visual C++ and uses the XCLIB library functions provided by the manufacturer of the frame grabber 130.

In an embodiment of the invention, the compressed images may be saved to the hard drive of the host computer 120 in real-time. In the saving process, two additional stages of compression may be done in real-time in the software application. As mentioned above, bytes 4-9 of each encoded bright pixel vector are zero. However, additional compression may be done by writing only the first 4 bytes out of 10 bytes to file, effectively removing all the zero bytes in each bright pixel vector. In an embodiment of the invention, another layer of compression may be done by detecting the size of the bright pixel array in each image frame with the recording algorithm and writing only the desired data to the hard drive of the host computer 120.

In an embodiment, the recording algorithm may also be responsible for detecting data overflow when the number of bright pixels exceeds the memory limit (e.g., 5000) of the memory devices 410a-j of the FPGA 315. The overflowed frame may be tagged in the file. The recording algorithm may also detect missed frames which may occur if the speed of recording cannot catch up with the frame rate.

In an embodiment, the compressed data may be stored in a custom video file format (.cpv, compressed video). Each custom video file starts with a file header that includes recording information such as original image size. To differentiate between frames, each frame may be enclosed between a 32-bit frame header indicating the number of that frame, and a 32-bit end-of-frame marker. The data in each frame may consist of 4-byte blocks, which are bytes 0-3 of a bright pixel vector.

Test data were collected with the turbulence tank setup. Runs of 900,000 frames at 500 fps (30 minutes) at maximum resolution (1280×1024 pixels) were recorded. Each compressed file occupied around 1.4 GB to 2 GB. If this experiment had been done with the original system, the total file size needed would have been 900,000×1280×1024 bytes=1099 GB. Therefore, these experiments achieved a compression ratio between 550 and 800. The average number of particles in view during these experiments was 16, and the compression ratio is expected to depend on particle density.

It will be appreciated that a benefit achieved by the compression circuit 115 is the capability of recording data over a long period of time without sacrificing spatial or temporal resolution. Long data sets allow for analysis of slow phenomena and improve statistical convergence.

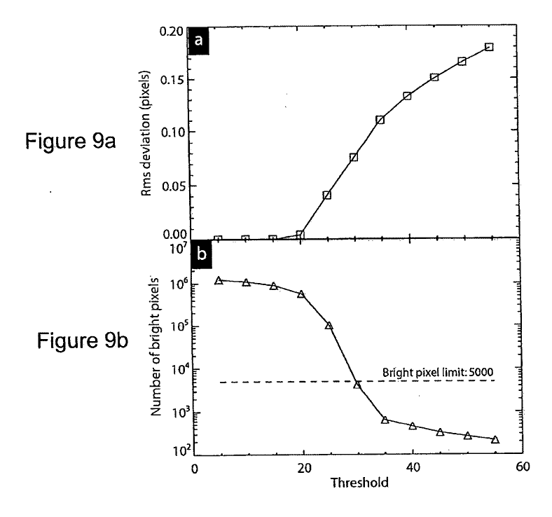

Since dim pixels around a particle that were below the threshold value are discarded, one may wish to check the accuracy of the new compression system in locating particles. A statistical test may be done to find the difference between locations of particles obtained from full images and compressed images. A series of 100 original images were filtered in software, producing the same effect as the compression circuit. Particle locations were found from the compressed images and compared to locations found from the original images. FIG. 9a shows deviation between particle positions measured from compressed images and the original positions measured from uncompressed images for several different values of the threshold. Only particles with peak brightness above 80 were considered. FIG. 9b shows the number of filtered pixels for each threshold. The dashed line shows the maximum number of filtered pixels allowed in the FPGA 315, e.g. 5000.

FIG. 9a shows that the error in locating particles increases as threshold increases, since more and more bright pixels are being cut off. For this data set, a threshold of 35 yields an accuracy of 0.11 pixel, and the total number of bright pixels is well below the system limit (FIG. 9b). Accuracy of about 0.1 pixel is typical for digital imaging of tracer particles, so this result indicates that position accuracy with this system is acceptable as long as the threshold is kept at a reasonably low level.

This compression circuit and compression method discussed herein demonstrate the possibility of real-time hardware-level image preprocessing of high speed video from particle tracking experiments. The compression circuit and compression method significantly improve data acquisition efficiency by achieving a high compression ratio and expanding experimental duration. In an embodiment, the compression system uses a commercially available camera and frame grabber and a custom designed image processing board. In other embodiments, other makes and models of cameras may be used, including customized cameras adopted specifically for the purpose of capturing particle tracking data. The cameras may have a number of output bandwidths and pixel contrast ranges. In still other embodiments, other customized hardware may be used to implement the image processing board.

There exist many possibilities for usage and expansion of this device. The use of a programmable chip in this circuit allows additional functions to be added to this device to perform more complicated signal preprocessing. For instance, one may implement more advanced compression schemes, or even implement feature-finding algorithms to locate the bright particles or objects in real-time. Potentially, this system may be implemented in many situations that involve high-speed recording of simple images such as time-resolved particle image velocimetry or x-ray imaging. The current limit of the system to images with less than 5000 bright pixels may be extended by replacing the Altera Cyclone chips with chips that have larger memory, or by changing the configuration of the output entirely by implementing feature-finding algorithms in hardware. Eventually, the image compression procedures may be integrated into the imaging device itself to eliminate the bottleneck formed by data offload from the imager. This may allow the imaging frame rate to increase by a factor similar to the compression ratios achieved.

In some embodiments, the image compression circuit may be integrated with the camera 110. For example, the image compression circuit may be located within a digital camera, with a mechanism on the digital camera for activating and controlling the compression. The image compression circuit may be implemented on the same circuit board as any other components within a digital camera, and may share one or more components with the other digital camera circuitry.

In other embodiments, some or all of the image compression circuit may be implemented using software executing on a general purpose computer, such as a PC. For example, one computer may be used to implement the compression circuit, while another computer performs the storage of the data to a long-term storage medium. Or, for example, some or all of the image compression circuit may be implemented using a general purpose processor located within a digital camera.

It will be appreciated that the compression circuit disclosed herein is configured to operate with any type of digital video camera. For example, the software application that controls the FPGA may be modified in the event different image transfer formats are used by two different cameras. The hardware of the compression circuit may also be modified if different digital cameras use a different data bus.

Although a particular configuration of the compression circuit has been shown, the present invention is not limited to this configuration and a variety of other arrangements may be used in other embodiments of the invention. For example, other filtering and compression schemes may be used to filter the video information to remove information related to portions of the images in which there are no imaged particles.

As will be appreciated by one of ordinary skill in the art, the compression circuit in accordance with an embodiment of the invention is adapted to compress images without compromising the spatial resolution, temporal resolution, and the duration over which data is acquired. The real-time compression circuit constructed in accordance with an embodiment of the invention may be used in portable applications, such as, for example, portable cameras or any other device for which portability by a person is desirable.

The foregoing illustrated embodiments have been provided solely for illustrating the structural and functional principles of the present invention and are not intended to be limiting. To the contrary, the present invention is intended to encompass all modifications, substitutions, alterations, and equivalents within the spirit and scope of the following appended claims.

What is claimed is:

1. A method of tracking a flow in a fluid medium comprising:
injecting a plurality of particles into the flow;
imaging the particles and fluid using a high speed digital video camera;
compressing images provided by the high speed digital video camera in real-time during the imaging; and
processing the compressed images.

2. The method of claim 1, wherein the compressing comprises filtering video data provided by the high speed digital video camera to remove data related to portions of the images in which there are no imaged particles.

3. The method of claim 1, wherein the compressing comprises thresholding pixels in image data in accordance with respective brightness values for the pixels.

4. The method of claim 3, wherein the compressing includes defining a vector for each pixel that has a brightness value past a predetermined threshold, the vector including the brightness value and a position of the pixel in the image data.

5. The method of claim 4, wherein the pixels have a brightness value above the predetermined threshold.

6. The method of claim 4, wherein the pixels have a brightness value below the predetermined threshold.

7. The method of claim 1, wherein the imaging is performed with a plurality of high speed digital video cameras.

8. The method of claim 1, wherein the compressing includes
identifying pixels in a set of image data that have a brightness value past a predetermined threshold;
determining a position of the identified pixels in the image data; and
for each of the identified pixels, defining a vector that includes the brightness value and the position of the identified pixel in the image data.

9. The method of claim 1, wherein the processing is performed in real-time during the compressing.

10. The method of claim 1, wherein the processing includes storing the compressed images.

11. The method of claim 1, wherein the processing includes reconstructing a motion of the particles in the fluid medium.

12. The method of claim 1, wherein the high speed digital video camera is configured to generate at least one hundred images per second.

13. A method of tracking objects comprising:
imaging the objects using a high speed digital video camera;
compressing images provided by the high speed digital video camera in real-time during the imaging, the compressing including
thresholding pixels in the images in accordance with respective brightness values for the pixels, and
defining a vector for each pixel that has a brightness value past a predetermined threshold, the vector including the brightness value and a position of the pixel in the images; and
processing the compressed images.

14. The method of claim 13, wherein the objects are particles and the compressed images are used to analyze a flow in a fluid medium.

15. A system for tracking a flow in a fluid medium comprising:
a high speed digital video camera configured to image particles and fluid;
a compression circuit configured to compress images provided by the high speed digital video camera in real-time during the imaging, the compression circuit including a processing system that is, configured to filter image data provided by the high speed digital video camera to remove data related to portions of the images in which there are no imaged particles; and
a storage medium configured to store the compressed images.

16. The system of claim 15, wherein the compression circuit is configured to define a vector for each pixel that has a brightness value past a predetermined threshold, the vector including the brightness value and a position of the pixel in an image frame.

17. A real-time image compression method comprising:
identifying pixels in a set of image data that have a brightness value past a predetermined threshold;
determining a position of each identified pixel in the image data; and
for each of the identified pixels, defining a vector that includes the brightness value and the position of the identified pixel in the image data.

18. The method of claim 17, wherein the pixels have a brightness value above the predetermined threshold.

19. The method of claim 17, wherein the pixels have a brightness below the predetermined threshold.

20. The method of claim 17, wherein the set of image data comprises a plurality of groups of pixels and the identifying further includes processing each group of pixels one at a time and wherein the vector has a same number of bytes as a sequence defined by each group of pixels.

21. The method of claim 20, wherein the sequence defined by each group of pixels and the vector each include 10 bytes.

22. The method of claim 17, wherein the identifying includes simultaneously processing a plurality of pixels with a corresponding plurality of filters to identify the one or more pixels that have a brightness value past the predetermined threshold.

23. The method of claim 22, wherein the vector has a same number of bytes as a sequence defined by the plurality of pixels.

24. The method of claim 23, wherein the sequence of bytes defined by the plurality of pixels is determined by a clock cycle of a camera that outputs the image data.

25. The method of claim 22, further comprising storing pixel information for the identified pixels having a brightness value past the predetermined threshold in a corresponding plurality of memory devices before outputting the vector.

26. The method of claim 25, wherein the memory devices are first-in-first-out memory devices.

27. The method of claim 25, wherein the pixel information for each identified pixel includes the brightness value and the position of the identified pixel in the image data.

28. The method of claim 25, further comprising reading out pixel information stored in the plurality of memory devices once all pixels of an image frame have been processed.

29. The method of claim 28, further comprising storing pixel information related to pixels of a subsequent image frame during the reading out of the pixel information of the image frame.

30. The method of claim 17, wherein the set of image data includes a plurality of image frames and wherein determining a position of the identified pixels in the image data includes counting lines in each image frame and determining frame breaks between two consecutives image frames.

31. The method of claim 17, wherein the vector is outputted to a frame grabber that is configured to construct an image frame.

32. The method of claim 17, wherein a compression ratio of an image frame is greater than about 100.

33. The method of claim 32, wherein the compression ratio is in a range between 100 and 1000.

34. The method of claim 17, wherein a compression ratio of an image frame is at least 10 for a bright pixel density greater than about 100.

35. A real-time image compression method comprising:
receiving a plurality of groups of pixels that define an image frame;
processing each of the plurality of groups of pixels, the processing including
identifying pixels in each group of pixels that have a brightness value past a predetermined threshold; and
determining a position of the identified pixels in the image frame; and
for each of the identified pixels, defining a vector that includes the brightness value and the position of the identified pixel in the image frame, the vector having a same number of bytes as a sequence defined by each group of pixels.

36. The method of claim 35, wherein the pixels in each group of pixels are simultaneously filtered.

37. A real-time image compression circuit comprising:
a plurality of filters configured to identify pixels in a set of image data that have a brightness value past a predetermined threshold;
a plurality of memory devices configured to store brightness information related to the identified pixels, the brightness information including a brightness value and a position of each of the identified pixels in the image data; and
a multiplexer configured to define for each identified pixel a vector that includes the brightness value and the position of the identified pixel in the image data.

38. The circuit of claim 37, wherein the plurality of filters are configured to identify pixels that have a brightness value above the predetermined threshold.

39. The circuit of claim 37, wherein the plurality of filters are configured to identify pixels that have a brightness value below the predetermined threshold.

40. The circuit of claim 37, wherein the set of image data comprises a plurality of group of pixels, each group of pixels being inputted to the plurality of filters one at a time and wherein the vector defined by the multiplexer has a same number of bytes as a sequence defined by each group of pixels.

41. The circuit of claim 40, wherein the sequence defined by each group of pixels and the vector each include 10 bytes.

42. The circuit of claim 37, wherein the plurality of filters are configured to simultaneously process a corresponding plurality of pixels to identify pixels in the set of image data that have a brightness value past a predetermined threshold.

43. The circuit of claim 42, wherein the vector has a same number of bytes as a sequence defined by the plurality of pixels.

44. The circuit of claim 43, wherein the sequence of bytes defined by the plurality of pixels is determined by a clock cycle of a camera that outputs the image data.

45. The circuit of claim 42, wherein each memory device of the plurality of memory devices is configured to store brightness information from a corresponding filter of the plurality of filters.

46. The circuit of claim 37, wherein the memory devices are first-in-first-out memory devices.

47. The circuit of claim 37, further comprising an output controller coupled to the plurality of memory devices and the multiplexer, the controller configured to read out brightness information stored in the plurality of memory devices once all pixels of an image frame have been processed.

48. The circuit of claim 47, wherein the plurality of memory devices are configured to store pixel information related to pixels of a subsequent image frame during the reading out of the pixel information of the image frame.

49. The circuit of claim 37, wherein the set of image data includes a plurality of image frames, the circuit further comprising a position counter configured to count lines in each image frame and to determine a frame break between two consecutive image frames.

50. The circuit of claim 37, further comprising an input coupled to an output of a camera and an output coupled to an input of a frame grabber.

51. The circuit of claim 37, wherein the compression ratio of an image frame is greater than about 100.

52. The circuit of claim 51, wherein the compression ratio is in a range between 100 and 1000.

53. The circuit of claim 37, wherein a compression ratio of an image frame is at least 10 for a bright pixel density greater than about 100.

54. A real-time image compression circuit comprising:
an input configured to receive a plurality of groups of pixels that define an image frame;
a plurality of filters configured to process each group of pixels one at a time and to simultaneously identify pixels in each group of pixels that have a brightness value past a predetermined threshold;
a plurality of memory devices configured to store brightness information related to the identified pixels, each memory device in the plurality of memory devices coupled to a corresponding filter of the plurality of filters, the brightness information including a brightness value and a position of each of the identified pixels in the image frame; and
a multiplexer configured to define for each identified pixel a vector that includes the brightness value and the position of the identified pixel in the image data.

55. A camera comprising:
an optical system configured to capture images of a scene;
a processing system configured to output a set of image data based on the captured images; and
an image compression circuit configured to compress the captured images in real time, the circuit comprising:
a plurality of filters configured to identify pixels in the set of image data that have a brightness value past a predetermined threshold;
a plurality of memory devices configured to store brightness information related to the identified pixels, the brightness information including a brightness value and a position of each of the identified pixels in the image data; and
a multiplexer configured to define for each identified pixel a vector that includes the brightness value and the position of the identified pixel in the image data.
